(19) United States
(12) Patent Application Publication
(10) Pub. No.: US 2015/0241348 A1
(43) Pub. Date: Aug. 27, 2015

(54) INFORMATION ACQUIRING APPARATUS AND INFORMATION ACQUIRING METHOD

(71) Applicant: CANON KABUSHIKI KAISHA, Tokyo (JP)

(72) Inventor: Toshihiko Ouchi, Machida-shi (JP)

(21) Appl. No.: 14/630,591

(22) Filed: Feb. 24, 2015

(30) Foreign Application Priority Data
Feb. 25, 2014 (JP) 2014-034610
Jan. 21, 2015 (JP) 2015-009744

(51) Int. Cl. G01N 21/59

(52) U.S. Cl. CPC G01N 21/59; G01N 2201/0636

(57) ABSTRACT

To acquire information of a test body by irradiating the test body with a terahertz wave, an information acquiring apparatus includes a photoconductive device, a terahertz wave irradiating unit, a terahertz wave irradiating unit, a detecting unit, and a light irradiating unit. The photoconductive device generates the terahertz wave by light incident from a light source. The terahertz wave irradiating unit separates the terahertz wave generated by the photoconductive device and light transmitting through, or reflecting from, the photoconductive device, and irradiates the test body with the separated terahertz wave. The detecting unit detects the terahertz wave from the test body. The light irradiating unit irradiates the detection unit with the light separated by the terahertz wave irradiating unit.

### BACKGROUND OF THE INVENTION

1. Field of the Invention

This disclosure relates to an information acquiring apparatus configured to acquire information of a test body by using a terahertz wave.

2. Description of the Related Art

In the related art, a non-destructive sensing technology using an electromagnetic wave (hereinafter, referred to simply as “terahertz wave”) having at least part of a frequency band from a millimeter waveband to a terahertz (THz) wave (from 30 GHz to 30 THz) is developed. Examples of application fields of the electromagnetic wave having the frequency band described above include an imaging technology for performing a safe fluoroscopic examination and a spectrometric technique or the like for inspecting coupling state of particles by obtaining absorption spectrum or a complex dielectric constant in an interior of a substance. In addition, a measuring technology for inspecting physical properties such as a carrier concentration, mobility, or dielectric constant, and a biological molecule analysis technology are developed.

U.S. Pat. No. 5,710,430 discloses an information acquiring apparatus using a terahertz wave time domain spectroscopy (THz-TDS: THz-time Domain Spectroscopy). Specifically, the information acquiring apparatus in U.S. Pat. No. 5,710,430 is configured to detect a terahertz wave by dividing light from a light source into two parts, one of which irradiates a terahertz wave generating unit as a pump light and the other one of which irradiates a detection unit as a probe light.

In a THz-TDS method, by changing a relative time difference between time required for the probe light to reach the detection unit and time required for the pump light to reach a photoconductive device for generation, a time waveform of the terahertz wave is obtained. When a test body, which is an object of measurement, is placed in a terahertz wave propagation path, the time waveform changes in accordance with physical properties and optical properties of the test body, so that the test body can be inspected from a change of the time waveform.

The photoconductive device is widely used as the terahertz wave generating unit used in the information acquiring apparatus disclosed in U.S. Pat. No. 5,710,430. The photoconductive device uses a light conducting film including a low-temperature growth semiconductor such as Si, GaAs, InGaAs and the like, and employs a system that generates a terahertz wave by a displacement current flowing by a movement of a carrier excited by light irradiation. A differential frequency generating system that causes two laser beams having a frequency difference to enter as incident light beams, and a system that generates a terahertz wave pulse by right rectification by irradiating a femtosecond pulse laser beam is known.

When splitting light from the light source into two parts as in U.S. Pat. No. 5,710,430, a power of the pump light used for generating the terahertz wave is weaker than an original power, and the terahertz wave generated from the photoconductive device is also weak. In order to increase the power of the terahertz wave, a terahertz wave having a higher power needs to be employed. However, the light source with a higher power may result in an increase in size and high costs. Since the power of the terahertz wave affects a measuring accuracy in the information acquiring apparatus, obtaining a terahertz wave with a higher power by using light from the light source efficiently is required.

### SUMMARY OF THE INVENTION

According to an aspect of the present invention, an information acquiring apparatus configured to acquire information of a test body by irradiating the test body with a terahertz wave includes a photoconductive device configured to generate the terahertz wave by light incident from a light source, a terahertz wave irradiating unit configured to separate the terahertz wave generated by the photoconductive device and light transmitting through, or reflecting from, the photoconductive device, and to irradiate the test body with the separated terahertz wave, a detecting unit configured to detect the terahertz wave from the test body, and a light irradiating unit configured to irradiate the detection unit with the light separated by the terahertz wave irradiating unit.

Further aspects of the present invention will become apparent from the following description of exemplary embodiments with reference to the attached drawings.

### BRIEF DESCRIPTION OF THE DRAWINGS

FIG. 1 is a configuration drawing illustrating an information acquiring apparatus of a first embodiment.

FIG. 2A is a time waveform of a terahertz wave acquired by the information acquiring apparatus of the first embodiment.

FIG. 2B is an intensity spectrum acquired by the information acquiring apparatus of the first embodiment.

FIG. 3 is a configuration drawing illustrating an information acquiring apparatus of a second embodiment.

FIG. 4 is a configuration drawing illustrating an information acquiring apparatus of a third embodiment.

FIG. 5 is a configuration drawing illustrating an information acquiring apparatus of a fourth embodiment.

### DESCRIPTION OF THE EMBODIMENTS

### First Embodiment

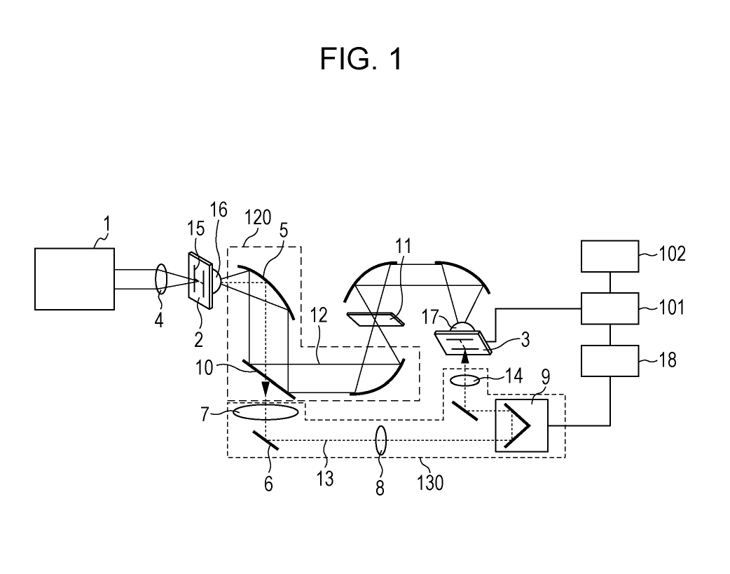

Referring now to FIG. 1, a configuration of an information acquiring apparatus of a first embodiment will be described. The information acquiring apparatus of this embodiment is a terahertz wave time domain spectrography (THz-TDS apparatus).

The information acquiring apparatus of this embodiment includes a light source 1, a photoconductive device 2, a detecting unit 3, changing unit 9, a terahertz wave irradiating unit 120, and a light irradiating unit 130 configured to irradiates the detecting unit 3 with part of light (excitation light) from the light source 1. A terahertz wave is generated by irradiating the photoconductive device 2 with light from the light source 1 without splitting. At this time, light which has not been absorbed by the photoconductive device 2 emits the terahertz wave coaxially, the emitted light enters the detecting unit 3 as a probe light. Here, the expression “light . . . emits the terahertz wave coaxially” means that an optical axis of the light from the photoconductive device 2 and an optical axis of the terahertz wave are in a same straight line. The term “the optical axis of the terahertz wave” denotes a line indicating a center of the beam of the propagating terahertz wave.

The light source 1 of this embodiment outputs femtosecond laser beam at portion configured to output light for generation and detection of the terahertz wave. The light source 1 may be a fiber laser. The light from the light source 1 is irradiated on the photoconductive device 2 via a lens 4.

The photoconductive device 2 generates a terahertz wave by light incident from the light source 1. In this embodiment, the femtosecond laser enters to generate a pulsed terahertz wave. The photoconductive device 2 includes a semiconductor film, and an antenna 15 having a minute gap (gap portion) provided on the semiconductor film.

Here, for example, if a central wave length of the femtosecond laser output from the light source 1 is 1.5 μm, the semiconductor film having a wavelength corresponding to a band gap (hereinafter, referred to as a band gap wavelength) of 1.5 μm or longer is used so as to achieve an efficient absorption of light in the photoconductive device. Examples of the semiconductor films as described above include those containing a low-temperature growth (LT-) InGaAs. However, the photoconductive device in which such a three-dimensional semiconductor is used has relatively low element resistance.

In contrast, in the case of the photoconductive device in which a semiconductor film having a band gap wavelength of 1.5 μm or shorter is used, a terahertz wave is generated even though almost no light is absorbed. This is generated by a movement of an excitation photo carrier caused by effects of excitation and multiphoton absorption via an intermediate level due to a defect existing in the crystal, which is generated in the case of an ultrahigh speed excitation process which causes a femtosecond laser to be irradiated. Examples of the semiconductor films as described above include those containing a low-temperature growth (LT-) GaAs, Si, and GaP. In this embodiment, since light transmitted through the photoconductive device 2 is used as a probe light, it is preferable to form the photoconductive device 2 by using a semiconductor film, which will be described later, configured to absorb less light.

Therefore, in this embodiment, the photoconductive device 2 such as a GaAs substrate or a Si substrate having the semiconductor film formed thereon by an epitaxial growth of LT-GaAs and the antenna 15 having a gap portion formed on the semiconductor film is used. The antenna 15 is formed by using AuGeNi/Au or the like.

A wavelength of light from the light source 1 preferably falls within a range not higher than that from a semiconductor used for the semiconductor film. In other words, an AIN/GaN/InN based semiconductor having a large band gap from among semiconductors used for the semiconductor film is exemplified. The band gap wavelength of GaN is approximately 0.37 p.m. There is also a semiconductor having a small band gap such as an AlSb/GaSb based semiconductor, and the band gap wavelength of GaSb is approximately 1.85 p.m. Since light is a super-short pulsed later, there is a width in wavelength. However, the central wavelength of the light is preferably longer than the band gap wavelength in order to reduce the absorption of the light. Therefore, light from the light source 1 preferably has a central wavelength falling within a range from approximately 0.4 μm to approximately 2.0 μm.

If the gap portion of the antenna 15 of the photoconductive device 2 is irradiated with pump light without separating light from the light source 1, light 13 having a power corresponding to several tens % of the power of the incident light goes out. In other words, if the power of light from the light source 1 is 200 mW in average, the light 13 in a range from 30 mW to 80 mW, for example, transmits through the photoconductive device 2, and goes out from a surface opposing a surface irradiated with light. If a non-reflection coating is applied on the photoconductive device 2 against light, a transmissivity of light is further improved. The extent of the power of the light 13 transmitting through the photoconductive device 2 maybe changed in accordance with the configuration of the photoconductive device 2.

A voltage is applied to the gap portion of the antenna 15 from a voltage source, which is not illustrated. By modulating this voltage, the terahertz wave generated thereby may also be modulated. For example, when detecting the terahertz wave by using a lock-in amplifier, modification based on the voltage to be applied to the gap portion of the antenna 15 may also be performed. As a matter of course, modification of the terahertz wave may be performed by using a light chopper.

A Si lens 16 is provided on the surface of the photoconductive device 2 opposing the surface irradiated with light. A terahertz wave 12 generated by irradiating the photoconductive device 2 with the light from the light source 1 goes out via the Si lens 16, and is irradiated on a test body 11 by the terahertz wave irradiating unit 120. The terahertz wave irradiating unit 120 is a portion configured to separate the terahertz wave 12 generated from the photoconductive device 2 and the light transmitting through the photoconductive device 2, and irradiate the test body 11 with the separated terahertz wave 12. Specifically, the terahertz wave 12 is collected by a parabolic mirror 5, and reaches a separating unit 10. The terahertz wave having reached the separating unit 10 is reflected by the separating unit 10 and irradiates the test body 11. The terahertz wave from the test body 11 is collected and enters the detecting unit 3.

The detecting unit 3 is a portion configured to detect the terahertz wave from the test body 11 and, in this embodiment, a photoconductive device which is the same as the photoconductive device 2 for generation is used. In other words, the detecting unit 3 is a photoconductive device including a light conducting film including a Lt-GaAs film and an antenna configured to also work as an electrode. The photoconductive device as the detecting unit 3 may be the one including an LT-GaAs film formed on the Si substrate by epitaxial growth in the same manner as the photoconductive device 1 as the generating unit. The detecting unit 3 is provided with a Si lens 17 configured to couple the terahertz wave from the test body 11 with the gap portion of the antenna. The detecting unit 3 is not limited thereto, and a known terahertz wave detector other than the photoconductive device such as a terahertz wave detector in which a non-linear optical crystal is used may be employed.

As described above, light 13 propagating coaxially with the terahertz wave 12 goes out from the photoconductive device 2 via the Si lens 16. In FIG. 1, a center axis of the light 13 is indicated by a dot line. The light 13 transmitted through the photoconductive device 2 reaches the separating unit 10 via the parabolic mirror 5 as illustrated in FIG. 1. The terahertz wave 12 and the light 13 are coaxial with each other up to the separating unit 10. The light 13 having reached the separating unit 10 is transmitted through the separating unit 10, and then enters the detecting unit 3 as probe light via the light irradiating unit 130 including a lens 7, a mirror 6, a lens 8, a changing unit 9, and a lens 14, and configured to irradiate the detecting unit 3 with part of the light from the light source 1. At this time, the light 13 enters the photoconductive device as the detecting unit 3 from a side opposite from the terahertz wave 12.

The changing unit 9 is a portion configured to change timing when probe light 13 enters the detecting unit 3 with respect to timing when the terahertz wave 12 enters the detecting unit 3. Specifically, the changing unit 9 adjusts the difference between time until the pump light reaches the photoconductive device 2 for generation from the light source 1 and time until the probe light 13 reaches the detecting unit 3. Accordingly, observation of a time waveform of the terahertz wave 12 is enabled by being activated as the THz-TDS apparatus.

The changing unit 9 of this embodiment is a delay stage having a reflecting optical system configured to reflect the probe light and a movable unit configured to move the reflecting optical system, and is configured to change an optical path length of the probe light by moving the delay stage. The amount of change of the optical path length in the changing unit 9 is controlled by a control unit 18. A rotating system may be applied as the movable unit. This disclosure is not limited thereto, and a method of changing the optical path length by changing a refractive index or the like in a probe light propagating path is also applicable.

When the terahertz wave 12 and the light 13 enter the detecting unit 3, the detecting unit 3 detects the terahertz wave. A signal of the terahertz wave 12 is detected by a signal acquiring unit 101 acquiring a current flowing through an antenna when the detecting unit 3 is irradiated simultaneously with the terahertz wave 12 and the light 13 as an output signal. A processing unit 102 forms the time waveform of the terahertz wave 12, which is information of the test body 11 by using the output signal acquired by the signal acquiring unit 101 such as an amplifier. The processing unit 102 may be provided further with a function of acquiring information such as optical properties and the shape of the test body 11 by using the acquired time waveform.

Here, the separating unit 10 included in the terahertz wave irradiating unit 120 will be described. The separating unit 10 is a portion configured to separate the terahertz wave 12 generated by the photoconductive device 2 and the light 13 transmitted through the photoconductive device 2, and a wave length separating element configured to separate irradiated light from one wavelength to another is used in this embodiment. Specifically, the wave length separating element formed by forming an ITO film (indium tin oxide) on a glass substrate is used. By this configuration, the terahertz wave 12 is reflected by the separating unit 10, and the light 13 is transmitted through the separating unit 10.

Although the separation of the terahertz wave 12 and the light 13 is performed by a plate-shaped member in this embodiment, a configuration in which the parabolic mirror 5 is formed of a transmissive material (for example, glass, resin, and the like) applied with an ITO coating on the surface thereof, is also applicable. In this case, an optical system having a mirror or the like arranged therein is arranged adequately, and the configuration of the light irradiating unit 130 is changed so that the photoconductive device as the detecting unit 3 is irradiated with the light 13 transmitting through the parabolic mirror 5. As the separating unit 10, known wave length separating elements such as a wire grid, a mesh, and the like may be used.

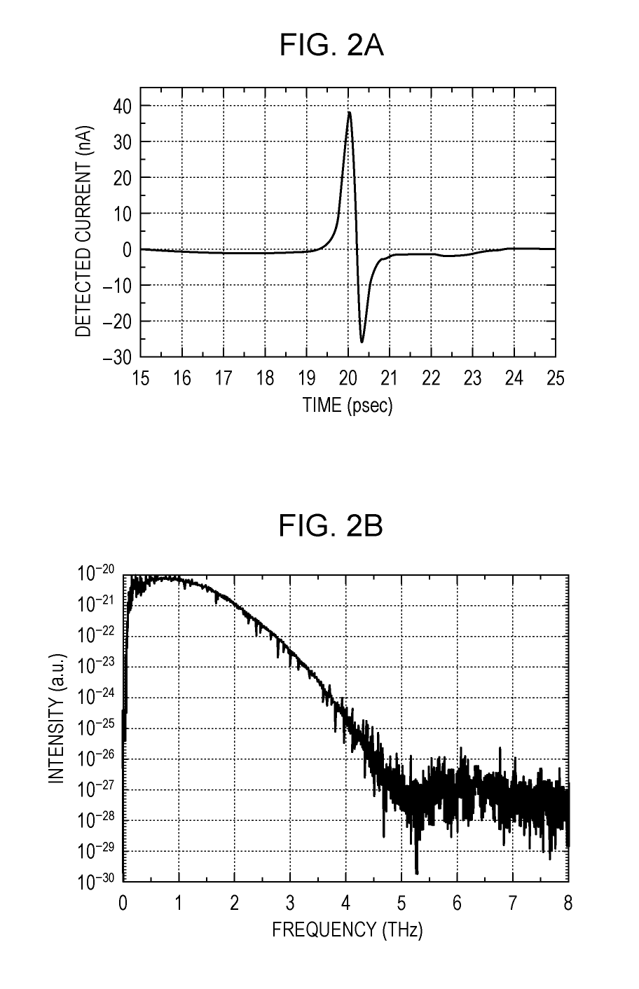

FIG. 2A is a time waveform of the terahertz wave 12 acquired by using the THz-TDS apparatus of this embodiment. FIG. 2B is an intensity spectrum acquired by Fourier transform of the time waveform in FIG. 2A. The time waveform illustrated in FIG. 2A is that acquired in the case where a pulse width of light from the light source 1 is 30 fs.

A half bandwidth of the terahertz wave 12 is approximately 300 fs, and a Fourier frequency at which an SN ratio becomes zero is approximately 5 THz. In detection of the terahertz wave, the probe light 13 irradiated on the detecting unit 3 is transformed to double the frequency (a wavelength of approximately 750 nm) by a secondary high bandwidth generating element (not illustrated) and is entered to the detecting unit 3. However, detection of the terahertz wave is possible without using the secondary high bandwidth generating element.

By using the information acquiring apparatus as described above, the time waveform of the terahertz wave irradiated on the test body 11 can be acquired as information of the test body 11. The optical performances, the state, and the shape of the test body 11 may be inspected by processing the time waveform. An image of the test body 11 imaged by the terahertz wave may be acquired by raster scanning of the test body 11.

In the information acquiring apparatus of this embodiment, the light from the light source 1 may be irradiated on the photoconductive device 2 for generation without splitting and, in addition, the light transmitting through and emitting from the photoconductive device 2 may be used as the probe light. Therefore, the light from the light source 1 may be used efficiently.

In comparison with the light from the light source 1 is split and hence having a reduced power is irradiated to generate a terahertz wave as in the related art, the photoconductive device 2 may be irradiated with light with higher intensity. Therefore, the power of the terahertz wave 12 can be improved without changing the light source 1. In particular, in the case where the photoconductive device using effects of excitation and multiphoton absorption via the intermediate level is used as a terahertz wave generating unit as in this embodiment, the power of the terahertz wave generating due to a non-linear phenomenon is proportional to 1.4th power or square of a peak value of a pulse of entering light. Therefore, a significant effect that the light from the light source 1 can be used without splitting light is achieved.

### Second Embodiment

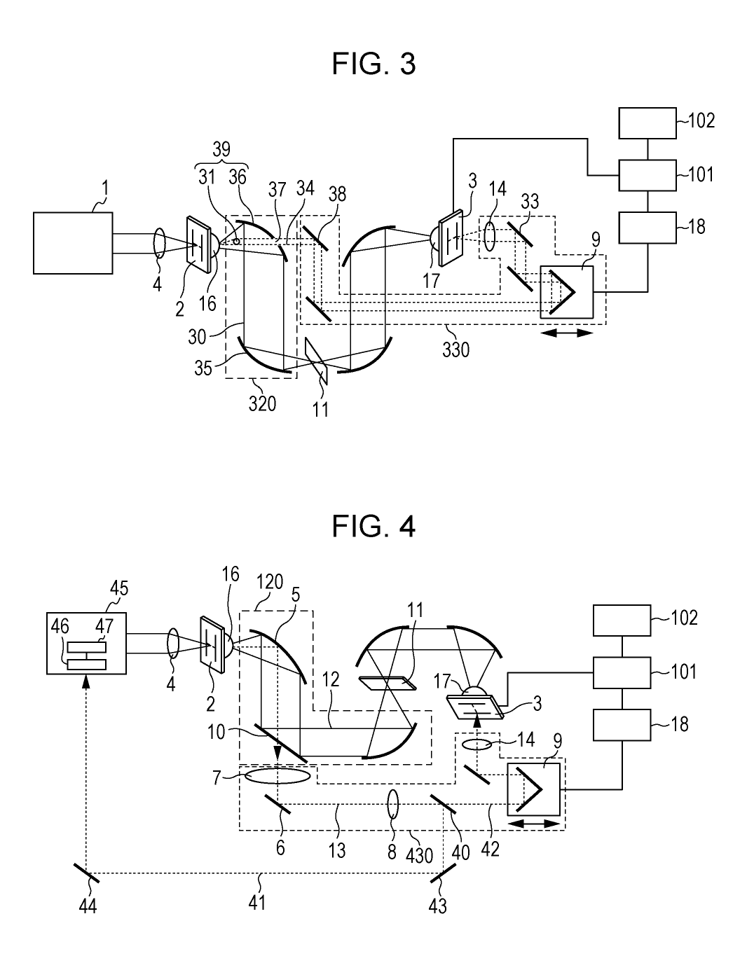

Referring now to FIG. 3, a configuration of an information acquiring apparatus of a second embodiment will be described. The information acquiring apparatus of this embodiment is different from the first embodiment in configuration of a terahertz wave irradiating unit 320. Specifically, the terahertz wave irradiating unit 320 of this embodiment includes a separating unit 39 including a small lens 31 and a parabolic mirror 36 having a hole formed therein, and the test body 11 is irradiated with a terahertz wave 30 separated by the separating unit 39 via the parabolic mirror 36 and a parabolic mirror 35. The small lens 31 is a ball lens. In FIG. 3, reference numerals of the same configuration as the first embodiment are omitted or the same as those in the first embodiment, and description of the same configuration is omitted.

The separating unit 39 of this embodiment includes the parabolic mirror (mirror) 36 having a ball lens 31 and a hole 37. The ball lens 31 formed of glass such as BK7 is arranged in the vicinity of the Si lens 16 of the photoconductive device on the side where the terahertz is generated. The ball lens 31 may be adhered to an apex of the Si lens 16. A diameter of the ball lens 31 in this embodiment is on the order of 3 mm, and those applied with a wide band AR coating is employed. However, this disclosure is not limited thereto.

Light 34 transmitting through the photoconductive device 2 is collected by the ball lens 31, and propagates as parallel light. Subsequently, the light 34 passes through the hole 37 formed in part of the parabolic mirror 36 for reflecting the terahertz wave 30, propagates through a light irradiating unit 330 including an optical system including a plurality of reflecting mirrors 38, the changing unit 9, a reflecting mirror 33, and a lens 14, and then is irradiated on the detecting unit 3. The diameter of the hole 37 is on the order of 3 mm φ in this embodiment. The light irradiating unit 330 is a portion configured to irradiate the detecting unit 3 with part of the light from the light source 1 as probe light.

In contrast, the terahertz wave 30 generated in the photoconductive device 2 is partly absorbed by the ball lens 31 or partly passes through the hole 37. However, major part of the terahertz wave 30 is reflected by the parabolic mirror 36 of the separating unit 39, and passes through a parabolic mirror 35 and is irradiated on the test body 11. The terahertz wave irradiated on the test body 11 enters the detecting unit 3 through the optical system and the Si lens 17.

Part of the terahertz wave 30 from the photoconductive device 2 irradiated on the ball lens 31 is partly reflected but transmit little because a large amount is absorbed by glass. However, the terahertz wave 30 is subjected to diffraction while being propagated, and hence no ring-shaped void is generated in an interior of the terahertz wave when being irradiated on the terahertz wave 30 of the photoconductive device as the test body 11 and the detecting unit 3. The hole 37 of the parabolic mirror 36 does not affect significantly in propagation of the terahertz wave 30 in the same manner. The actions of the information acquiring apparatus and measurement of the devices under test are the same as those in the first embodiment.

In the information acquiring apparatus of this embodiment, the light from the light source 1 may be irradiated on the photoconductive device 2 without splitting and, in addition, the light going out from the photoconductive device 2 may be used as the probe light. Therefore, the light form the light source 1 may be used efficiently.

The separating unit 39 of this embodiment is reduced in size in comparison with the separating unit 10 used in the first embodiment, and hence contributes to a reduction in size of the information acquiring apparatus.

### Third Embodiment

Referring now to FIG. 4, a configuration of an information acquiring apparatus of a third embodiment will be described. In the embodiment described above, the light from the photoconductive device 2 which generates the terahertz wave is used as the probe light. In contrast, in this embodiment, in addition to a configuration in which the light from the photoconductive device 2 is used as the probe light, a configuration to be used in a feedback system for stabilizing light output from a light source 45 is also added. By stabilizing the light output from the light source 45, stabilization of the generated terahertz wave is enabled. The reference numerals of the same configurations as the first embodiment are omitted or the same.

The terahertz wave 12 and the light 13 from the photoconductive device 2 are separated by the separating unit 10 included in the terahertz wave irradiating unit 120 in the same manner as the first embodiment. The configuration in which the terahertz wave 12 is introduced to the test body 11 and the detecting unit 3 is the same as that in the first embodiment, and hence detailed description will be omitted.

A light irradiating unit 430 of this embodiment is a portion configured to irradiate the detecting unit 3 with part of the light from the light source 1, and includes the lens 7, the mirror 6, the lens 8, a light splitting unit 40, the changing unit 9, and the lens 14. The light 13 separated by the separating unit 10 reaches the light splitting unit 40 via the lens 7, the mirror 6, and the lens 8. The light splitting unit 40 splits the light 13 from the photoconductive device 2 into a first light 41 and a second light 42. The second light 42 split by the light splitting unit 40 irradiates the detecting unit 3 with the second light 42 split by the light splitting unit 40 as the probe light in the same manner as the first embodiment.

The first light 41 (the power of the first light 41 is on the order of 10% of the power of the second light 42, for example) split by the light splitting unit 40 is fed back to the light source 45 through mirrors 43 and 44.

The light source 45 includes an adjusting mechanism including a light detecting unit 46 configured to detect the first light 41 and an output adjusting unit 47 configured to adjust an output of light by using a result of detection of the light detecting unit 46. With this configuration, adjustment to detect the fed back first light 41 by the light detecting unit 46, and keep the output constant by the output adjusting unit 47 on the basis of variations in intensity thereof is performed. A known method and a known apparatus may be used as the adjusting mechanism and, for example, a method of providing a variable ND filter on the laser output level is applicable. The adjusting mechanism may be integrated in the light source 45 or may be provided partly or entirely to the outside of the adjusting mechanism.

In the information acquiring apparatus of this embodiment, the photoconductive device 2 can be irradiated with light from the light source 45 without being split. In addition, the light which is not absorbed by the photoconductive device 2 and goes out is used as the probe light, and simultaneously, is fed back to the light source 45 for stabilizing the light from the light source 45. Therefore, the light from the light source 45 may be used efficiently.

In this embodiment, the light transmitting through the photoconductive device 2 is fed back to allow an object at a short distance to be monitored by the power of the light that the photoconductive device 2 is irradiated with. Therefore, stabilization of the power of light, and hence stabilization of an output of the terahertz wave 12 generating from the photoconductive device 2 with high degree of accuracy is achieved.

The configurations of the terahertz wave irradiating unit and the light irradiating unit are not limited to the configurations described in this embodiment, and a feedback system may be added to the configurations of other embodiments described previously and described below. Although the light from the photoconductive device is split and one of those is used as the probe light and the other one is fed back to the light source 45 in this embodiment, a configuration only with a feedback system is also applicable.

### Fourth Embodiment

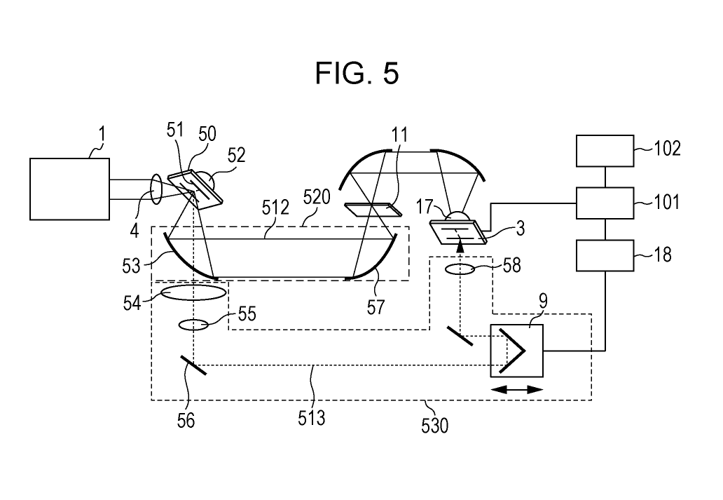

Referring now to FIG. 5, a configuration of an information acquiring apparatus of a fourth embodiment will be described. In this embodiment, an arrangement of a photoconductive device 50 on the side where the terahertz wave is generated is changed, so that the light reflected from a surface which the light of the photoconductive device 50 enters and the terahertz wave generated from the surface where the light from the photoconductive device 50 enters are used. The configuration of a terahertz wave irradiating unit 520 is also different from those in the embodiments described above.

The terahertz wave irradiating unit 520 includes a separating unit 53 and a parabolic mirror 57. A terahertz wave 512 generated in the photoconductive device 50 and light 513 reflected from the photoconductive device 50 are separated by the separating unit 53. The separating unit 53 is employed a parabolic mirror formed by depositing the ITO film on the surface of the member having a light transmissivity. The configurations of the separating unit 53 are not limited thereto, and those described above or later may be employed.

The terahertz wave 512 generated from the photoconductive device 50 propagates in the form of a parallel terahertz wave by being reflected from the separating unit 53 and then is collected. Subsequently, the test body 11 is irradiated with the terahertz wave 512 via the parabolic mirror 57. The terahertz wave from the test body 11 enters the photoconductive device as the detecting unit 3 through the optical system and the Si lens 17.

The light 513 reflected from the photoconductive device 50 is transmitted through the separating unit 53, and is irradiated on the detecting unit 3 via a light irradiating unit 530 having two optical lenses 54 and 55, a mirror 56, the changing unit 9, and a lens 58. The light irradiating unit 530 is a probe light irradiating unit configured to irradiate the detecting unit 3 with part of the light from the light source 1. Specifically, the light 513 is separated from the terahertz wave 512 at the separating unit 53, and then a beam diameter is converted from by the two optical lenses 54 and 55, and reaches the changing unit 9 via the mirror 56. Then, in the same manner as the first embodiment, the light 513 passes through the changing unit 9 and the optical lens 58, and is irradiated on the detecting unit 3. A method of acquiring the time waveform of the terahertz wave from the specimen 11 is the same as the embodiment described above.

The photoconductive device 50 configured to generate the terahertz wave includes a Si lens 52 arranged on a surface opposing a surface which the light from the light source 1 enters. This is not for causing the terahertz wave to go out therefrom, but for preventing generation of a multiple pulse by the terahertz wave reflecting from the surface of the photoconductive device 50 opposing the surface which the light enters.

In the information acquiring apparatus of this embodiment, the light from the light source 1 may be irradiated on the photoconductive device 50 without splitting and, in addition, the light reflecting from the photoconductive device 50 may be used as the probe light. Therefore, the light form the light source 1 may be used efficiently.

In this embodiment, the terahertz wave generated by the photoconductive device 50 and the light reflected from the photoconductive device 50 do not transmit through a substrate of the photoconductive device 50. Therefore, the information acquiring apparatus of this embodiment is characterized in that both a terahertz wave and light having a narrow pulse width can be obtained without being affected by dispersion in a semiconductor crystal.

In the embodiments described above, the transmissive information acquiring apparatus configured to detect the terahertz wave transmitting through the detection is described. However, this disclosure can be applied to a reflective information acquiring apparatus configured to detect a terahertz wave reflected from the test body. A configuration of a Total Reflectance (ATR: Attenuated Total Reflectance) type in which the test body is disposed on a totally reflecting surface is also applicable. A configuration including a position changing unit configured to change a position of irradiation of the test body with the terahertz wave, and an image forming unit configured to form an image of the test body imaged by using information of the test body acquired at every different position of the test body is also applicable. Various optical system configured to propagate a terahertz wave and light including the terahertz wave irradiating unit and the light irradiating unit are not limited to those in the embodiments described above, and may be changed in configuration as needed.

Although the case where the light output from the light source is a femtosecond laser has been described, a configuration in which the photoconductive device is irradiated with a plurality of single wavelength lasers having wavelengths slightly different from each other is also applicable. In such a case, the terahertz wave in accordance with differential frequencies among the plurality of single wavelength lasers is generated. The wavelength of the generated terahertz wave can be changed by changing the wavelength of the single wavelength laser.

The separating unit in the case of separating the terahertz wave generated by the photoconductive device in the irradiating unit and the light transmitting through the photoconductive device or reflected by the photoconductive device is not limited to the method described in the embodiments described above. As a specific example, a thin film mirror (a pellicle mirror) having a multilayer film of dielectric material is exemplified. The pellicle mirror having a polyester thin film and having a thickness of 100 μm or smaller, preferably, several tens μm or smaller as a whole, is arranged in the irradiating unit to allow the terahertz wave to transmit through the pellicle mirror. In contrast, light is reflected from the pellicle mirror, and hence the terahertz wave and the light can be separated.

In the embodiments described above, the test body is irradiated with the terahertz wave after the terahertz wave generated by entry of light from the light source into the photoconductive device and light from the photoconductive device have separated. This disclosure is not limited thereto, and a configuration in which the terahertz wave and the light are separated and introduced to the detection unit respectively after the irradiation of the test body is also applicable. In this case, since the light irradiated on the test body is reflected and scattered by the test body, a test body having a less influence on light is preferably selected.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-034610 filed Feb. 25, 2014 and No. 2015-009744 filed Jan. 21, 2015, which are hereby incorporated by reference herein in their entirety.

What is claimed is:

1. An information acquiring apparatus configured to acquire information of a test body by irradiating the test body with a terahertz wave, the information acquiring apparatus comprising:
a photoconductive device configured to generate the terahertz wave by light incident from a light source;
a terahertz wave irradiating unit configured to separate the terahertz wave generated by the photoconductive device and light transmitting through, or reflecting from, the photoconductive device, and to irradiate the test body with the separated terahertz wave;
a detecting unit configured to detect the terahertz wave from the test body; and
a light irradiating unit configured to irradiate the detection unit with the light separated by the terahertz wave irradiating unit.

2. The information acquiring apparatus according to claim 1, further comprising a splitting unit configured to split the light separated by the terahertz wave irradiating unit into first light and second light;
a light detecting unit configured to detect the first light; and
an adjusting unit configured to adjust an output of light from the light source by using a result of detection of the light detecting unit,
wherein the light irradiating unit irradiates the detection unit with the second light.

3. The information acquiring apparatus according to claim 1,
wherein the photoconductive device includes a semiconductor, and
wherein a central wavelength of the light from the light source is longer than a wavelength corresponding to a band gap of the semiconductor.

4. The information acquiring apparatus according to claim 1,
wherein a central wavelength of the light from the light source falls within a range from 0.4 μm to 2.0 μm.

5. The information acquiring apparatus according to claim 1,
wherein an optical axis of the light transmitting through, or reflected from, the photoconductive device and an optical axis of the terahertz wave generated by the photoconductive device are in a same straight line.

6. The information acquiring apparatus according to claim 1,
wherein the terahertz wave irradiating unit includes a wavelength separating element configured to separate the terahertz wave generated by the photoconductive device and the light from the photoconductive device.

7. The information acquiring apparatus according to claim 1,
wherein the terahertz wave irradiating unit includes a lens configured to collect light transmitting through, or reflected from, the photoconductive device, and a mirror configured to reflect the terahertz wave generated by the photoconductive device, and
wherein the mirror is provided with a hole configured to allow light collected by the lens to pass through the hole.

8. The information acquiring apparatus according to claim 1, further comprising:
a position changing unit configured to change a position of irradiating the test body with the terahertz wave; and
an image forming unit configured to acquire an image of the test body by using a result of detection of the detection unit.

9. A method for an information acquiring apparatus configured to acquire information of a test body by irradiating the test body with a terahertz wave, the method comprising:
generating, via a photoconductive device, the terahertz wave by light incident from a light source;
separating, the terahertz wave generated by the photoconductive device and light transmitting through, or reflecting from, the photoconductive device, and irradiating the test body with the separated terahertz wave;
detecting, via a detecting unit, the terahertz wave from the test body; and
irradiating, the detection unit with the light separated in the step of separating.
